(19) United States
(12) Patent Application Publication
(10) Pub. No.: US 2009/0127919 A1
(43) Pub. Date: May 21, 2009

(54) WHEEL WEIGHT WITH UNITARY BODY AND CLIP

(75) Inventor: Cordell Wayne Burnett, Lebanon, TN (US)

Correspondence Address: Steven H. Meyer, Esq., 213 Yale Road, Wayne, PA, 19087-2650, US

(73) Assignee: PERFECT EQUIPMENT INC., A DELAWARE CORPORATION, LaVergne, TN (US)

(21) Appl. No.: 11/943,245

(22) Filed: Nov. 20, 2007

(51) Int. Cl. F16F 15/32; B23P 15/00

(52) U.S. Cl. 301/5.21; 29/557

(57) ABSTRACT

A wheel-balancing weight mounts to a wheel with a flange. The weight is formed as a unitary member having a unitary body and clip such that the clip as formed is attached to and emerges from the body as formed. The body provides a predetermined mass to the weight and the clip securely grasps the flange of the wheel to secure the weight thereto. The weight is formed by forming a slug to include a formed body portion corresponding to the body and a formed clip portion corresponding to the clip, and bending over at least a portion of the formed clip portion of the slug to form the clip.

### FIELD

The present disclosure relates to a wheel-balancing weight for balancing a wheel of a vehicle or the like. More particularly, the present disclosure relates to a wheel balancing weight with a unitary body and clip.

### BACKGROUND

In the manufacture of pneumatic tires and also wheels and rims for pneumatic tires, it is exceedingly difficult if not impossible to produce a tire, a wheel, or the combination thereof in perfect rotational balance. As known, when out of balance, such a tire, wheel, or combination thereof, vibrates excessively upon rotation and can cause damage to adjacent, coupled to and/or related components. Moreover, when the tire and wheel are coupled to a moving vehicle such as a passenger car, the vibration can be uncomfortable to an occupant

Accordingly, and as is known, such tire, wheel, or combination thereof is balanced by appropriately applying one or more counter-balancing weights to compensate for a measured imbalance. Typically, although by no means absolute, in the case where a tire is mounted to a wheel of a vehicle, the wheel includes a circumferential flange or lip at a rim on either axial side thereof and a weight of appropriate mass is applied at each flange at an appropriate circumferential location thereof. Methods of measuring imbalance and determining where to apply the counter-balancing weights are generally known to the relevant public and therefore need not be described herein.

Heretofore, such a counter-balancing weight for a vehicle has been constructed to have a body forming the majority of the mass of the weight and a clip by which the body is secured to the flange of a wheel, where the clip is attached to the body by any of several attaching mechanisms. For example, the clip may be swaged to a face of the body or affixed to a face of the body by way of one or more screws, rivets, expansion bolts, or the like. Additionally, the body may be formed from a molten material such as lead or the like around a clip formed from sheet steel or the like.

Notably, though, the use of lead has come to be discouraged for environmental reasons, among others. Moreover, attaching the clip to the body requires numerous production steps, each of which can introduce complexity and error to the overall manufacturing process. Further, attaching separate components to form a weight introduces join or attachment issues, including the possibility of attachment failure at the attachment location and corrosion at such attachment location, particularly from water infiltrating the attachment location and flexing that may occur at such attachment location.

Accordingly, a need exists for a wheel-balancing weight with a clip and a body that is formed from a material other than lead, where the clip is attached to the body in a simplified manner and with reduced or eliminated join issues. More particularly, a need exists for such a wheel-balancing weight where the clip and body are formed as a unitary member with a reduced number of production steps. Still more particularly, a need exists for such a wheel-balancing weight that is formed as a unitary steel member based on a forming and tooling process and therefore is affordable in cost.

### SUMMARY

The aforementioned need is satisfied by a wheel-balancing weight for mounting to a wheel with a flange. The weight is formed as a unitary member having a unitary body and clip such that the clip as formed is attached to and emerges from the body as formed. The body provides a predetermined mass to the weight and the clip securely grasps the flange of the wheel to secure the weight thereto. The weight is formed by forming a slug to include a formed body portion corresponding to the body and a formed clip portion corresponding to the clip, and bending over at least a portion of the formed clip portion of the slug to form the clip.

### BRIEF DESCRIPTION OF THE DRAWINGS

The foregoing summary as well as the following detailed description of various embodiments of the present invention will be better understood when read in conjunction with the appended drawings. For the purpose of illustrating the various embodiments of the invention, there are shown in the drawings embodiments that are presently preferred. As should be understood, however, the invention is not limited to the precise arrangements and instrumentalities shown. In the drawings:

FIG. 1 is a broken-away perspective view of a wheel-balancing weight in accordance with the prior art;

FIG. 2 is a broken-away perspective view of a wheel-balancing weight in accordance with various embodiments of the present invention, where the weight includes a unitary body and clip;

FIG. 3 is a front elevation view of a formed slug employed to form a weight akin to the weight of FIG. 2 in accordance with various embodiments of the present invention;

FIG. 3A is a side elevation view taken along the line 3A-3A of FIG. 3;

FIG. 4 is a front elevation view of the formed slug of FIGS. 3 and 3A with excess material trimmed away to define a flap that will be bent over to form a clip portion in accordance with various embodiments of the present invention;

FIG. 4A is a side elevation view taken along the line 4A-4A of FIG. 4;

FIG. 5 is a front elevation view of the formed slug of FIGS. 4 and 4A with the flap bent over to form the clip portion and with the body portion bent to an arcuate shape in accordance with various embodiments of the present invention;

FIG. 5A is a side elevation view taken along the line 5A-5A of FIG. 5; and

FIG. 6 is a flow diagram showing key actions performed to form a weight akin to the weight of FIG. 2 in accordance with various embodiments of the present invention.

### DETAILED DESCRIPTION OF PREFERRED EMBODIMENTS

Certain terminology may be used in the following description for convenience only and is not considered to be limiting. For example, the words “left”, “right”, “upper”, “lower”, “top”, “bottom”, “front”, and “back” designate directions in the drawings to which reference is made. Likewise, the words “inwardly” and “outwardly” are directions toward and away from, respectively, the geometric center of the referenced object. The terminology includes the words above specifically mentioned, derivatives thereof, and words of similar import.

### Wheel-Balancing Weights in General

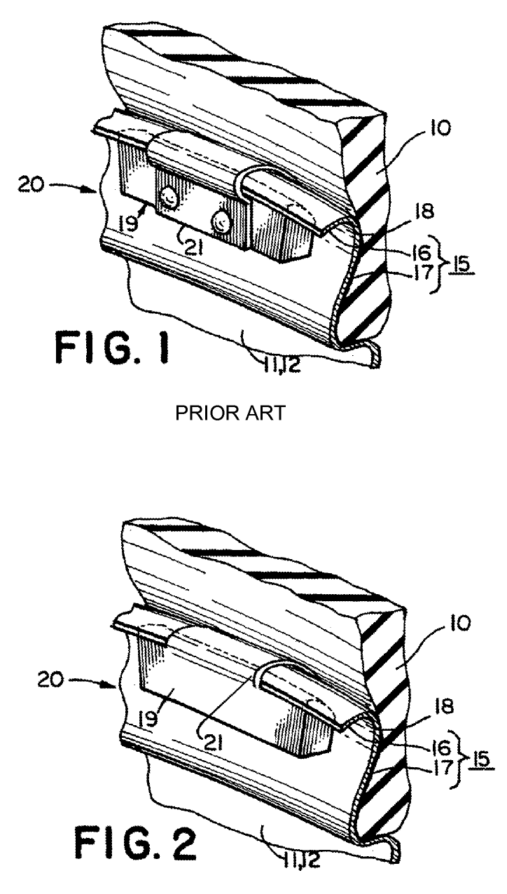

As shown in FIGS. 1 and 2, a pneumatic or other tire 10 such as may be used in connection with an automotive vehicle or the like is mounted upon a rim 11 of a vehicle wheel 12 or the like. An example of such a tire 10, rim 11, and wheel 12 is shown and disclosed in U.S. Pat. No. 6,553,831, hereby incorporated by reference in its entirety. U.S. Pat. Nos. 7,216,938 and 7,249,804 are also hereby incorporated by reference in their entirety.

It is to be appreciated that the tire 10 may be mounted to the wheel 12 in any conventional or unconventional manner and that the tire 10 may be of any variety or manufacture without departing from the spirit or scope of the present invention. The tire 10 and wheel 12 or wheel 12 alone may be balanced manually or by spin balancing or by any other method without departing from the spirit and scope of the present invention.

As is known, a wheel 12 and a wheel 12 with tire 10 mounted thereupon are balanced with respect to the rotational axis thereof and in particular can be balanced on both the axially inboard and outboard sides of the wheel 12 at or about the rim 11 thereof. Generally, a wheel 12 with or without a tire 10 mounted thereupon is balanced by measuring the imbalance and then attaching a weighted mass or weight 20 at a circumferential location on the rim 11 of the wheel 12 such that the measured imbalance is counter-balanced by the weight 20. Such balancing is often performed on both the inboard and outboard sides of the wheel 12.

Typically, the rim 11 of a wheel 12 at each axial side thereof extends both axially and circumferentially. The wheel 12 also includes a central well portion (not shown) through which bolts on a vehicle typically extend to attach the wheel 12 to such vehicle. As seen in FIG. 1, the rim 11 includes a flange 15 extending generally axially and/or radially outwardly from the rim 11 and circumferentially around the rim 11. The rim 11 typically has an inboard flange 15 corresponding to an inboard side of the tire 10 and an outboard flange 15 corresponding to an outboard side of the tire 10, only one such flange 15 being shown in FIG. 1.

Each flange 15 as shown may be constructed during formation of the wheel 12 by crimping or otherwise forming a portion of the rim 11 so as to create a generally axially extending lip 16. As seen in FIG. 1, the lip 16 may reside at the distal portion of a generally radially outwardly extending brim 17. As may be appreciated, in addition to radially displacing the lip 16 from the main portion of the rim 11, the brim 17 also acts to secure the pneumatic tire 10 onto the rim 11. Also, acting together, the lip 16 and the brim 17 of the flange 15 define a pocket 18 within which the weighted body 19 of a wheel balancing weight 20 may be nestled to achieve proper balancing. As may be appreciated, the pocket 18 defined by the flange 15 extends generally circumferentially with respect to the wheel, and the weighted body 19 should therefore also extend in an arcuate manner so as to follow the generally circumferential pocket 18 and be nestled therein.

It is to be recognized that the flange 15 may also have other dimensional features without departing from the spirit and scope of the present invention. As shown in the drawings, the flange 15 extends generally axially and generally radially outwardly in an S-shape as viewed in toroidal cross-section, but it should be understood that the flange 15 may extend in another direction. Additionally, the flange 15 may vary in dimension, location and in number, all without departing from the spirit and scope of the invention.

Typically, a wheel balancing weight 20 such as that shown in FIG. 1 includes a clip 21 for attaching the weighted body 19 thereof to the flange 15 of the wheel 12. The clip 21 is constructed in an appropriate shape and manner from a durable material such as spring steel so that the clip 21 securely grips the flange 15 and attaches the body 19 thereto while nestling same in the pocket 18 formed by such flange 15. The body 19 is constructed from a material other than lead, primarily for environmental reasons.

In the prior art and as is shown in FIG. 1, it was typical to form the wheel-balancing weight 20 by forming the body 19 and clip 21 separately and then attaching one to the other, as is shown in FIG. 1. Alternately, the clip 21 was formed and the body was then formed by positioning molten lead around a portion of the formed clip 21, perhaps with the aid of a mold. However, and as was set forth above, the use of lead has come to be discouraged for environmental reasons, among others.

Moreover, and again, attaching the clip to the body requires numerous production steps, each of which can introduce complexity and error to the overall manufacturing process. For example, each of the body 19 and the clip 21 must be formed with appropriate attaching features, each of which must be located with relatively high precision. Thereafter, the formed body 19 and the formed clip 21 must be appropriately co-located with respect to each other while attachment takes place. Note here that such attachment can take place by swaging, riveting (shown in FIG. 1), bolting, screwing, or the like, each of which must be done with precision and care.

Additionally, attaching a separate body and clip 19, 21 to form a weight 10 introduces join or attachment issues, including the possibility of attachment failure at the attachment location and corrosion at such attachment location. For example, if swaging or riveting is performed with too much force, the body 19 or clip 21 may break, while screwing overly tightly can strip threads formed in the body 19 and result in the body 19 separating from the clip 21. Note too that if a screw or rivet is employed to attach the body and clip 19, 21, such screw or rivet can itself fail and also result in the body 19 separating from the clip 21.

Further, the attachment location at which the body and clip 19, 21 meet represents the point at which damage from corrosion is most likely to take place. As may be appreciated, such attachment location ca form a compartment that attracts and retains water, which is the main source of such corrosion. Also, such attachment location is where the clip 21 flexes with respect to the body 19 when strained, and such flexure can lead to cracking and metal fatigue at such attachment location.

Wheel-Balancing Weight with Unitary Clip and Body

Accordingly, and in various embodiments of the present invention, the attachment location is eliminated from the weight 20 by forming the weight as a unitary member having the body and clip 19, 21, as is shown in FIG. 2. Thus, the body and clip 19, 21 as formed are already attached to one another and need not be so attached in a separate operation after the body 19 and/or clip 21 are formed. Note here that the unitary weight 20 having the body and clip 19, 21 may be formed from most any appropriate material without departing from the spirit and scope of the present invention. That said, the material should be dense enough to provide heft to the body 19 of the unitary weight 20, and yet resilient enough to allow the clip 21 of the unitary weight 20 to repeatedly spring into gripping contact with a mounted-to flange 15 without unduly from fatigue. Accordingly, such material is typically a steel material.

As may be appreciated, the unitary weight 20 having both the body and clip 19, 21 as formed has a general shape and structure akin to that of prior art weights. Thus, the body 19 extends generally transversely and circumferentially for some distance that generally corresponds to a stated mass of the weight 20, and the clip also extends generally transversely, albeit a length that is usually less than that of the body 19. However, such shape and structure does differ based on the absence of any distinct attachment mechanism for attaching the body 19 to the clip 21, such attachment mechanism being unnecessary in the various embodiments of the present invention. Instead, the clip 21 as unitarily formed with the body 19 to form the weight 20 merges with such body 19.

As shown in FIG. 2, the body 19 of the unitary weight 20 is formed to have an outboard face for facing generally axially away from the mounted-to wheel 12 and an inboard face for facing toward the mounted-to wheel 12 and the flange 15 of the rim 11 thereof. As seen, the inboard face further has a gripping portion that grips the lip 16 of the flange 15 in concert with the clip 21, and a brim portion that faces generally axially toward the brim 17 of the flange 15, more or less. As shown, the outboard face is generally planar, the gripping portion of the inboard face extends generally normally from the outboard face and curves toward and joins the brim portion of the inboard face, and the brim portion of the inboard face is generally opposite the outboard face. As should be appreciated, however, the body 19 as shown in FIG. 2 is merely exemplary and may have any other facial configuration without departing from the spirit and scope of the present invention.

Notably, the body 19 may be formed to closely follow the lip 16 and brim 17 of the flange 15 of the rim 11 when the weight is mounted to such rim 11 at such flange 15. Thus, such body 19 is more intimately nestled within the pocket 18 defined by the flange 15 when the weight 20 is mounted to such flange 15 at an appropriate circumferential location thereof. As was set forth above, the weighted body 19 of the weight 20 should be well-nestled in such pocket 18 to achieve proper balancing. Accordingly, the body 19 extends in an arcuate manner so as to enhance such nestling in the generally circumferential pocket 18.

As also shown in FIG. 2, the clip 21 of the unitary weight 20 emerges from the body 19 of such unitary weight 20 at about the intersection of the outboard face and the gripping portion of the inboard face. As seen, the clip 21 as emerged from the body extends in a generally curving manner, firstly in a generally radial direction generally away from the gripping portion of the inboard face and the axis of the wheel, and then secondly around the flange and in a generally axial direction with the gripping portion of the inboard face and toward the tire 10, and then thirdly transitioning toward a generally radial direction toward the axis of the wheel and further with the gripping portion of the inboard face.

The clip 21 thus curves along with but is separable from the gripping portion of the inboard face of the body 19 such that the lip 16 of the flange 15 may be fitted and securely gripped therebetween. As a result, the clip 21 as shown in FIG. 2 grips the flange 15 along with the body 19, and the clip 21 and the body 19 in combination define a compartment within which the flange 15 is received. As should be appreciated, however, the clip 21 as shown in FIG. 2 is merely exemplary and may have any other configuration without departing from the spirit and scope of the present invention.

For example, the clip 21 may emerge from the body 19 at an angle with respect to the outboard face of the body 19, as is shown in FIG. 2, or in a generally parallel and co-planar manner with respect to such outboard face, as will be seen in FIG. 5A. Also, the clip 21 may alternately emerge from the body 19 more closely to the brim portion of the inboard face of such body 19 and then curve in a generally axial direction away from the tire 10 before curving in the generally radial direction generally away from the axis of the wheel, in which case the clip would define the aforementioned compartment without the aid of the body 19 and would grip the flange 15 in such compartment without the aid of such body 19.

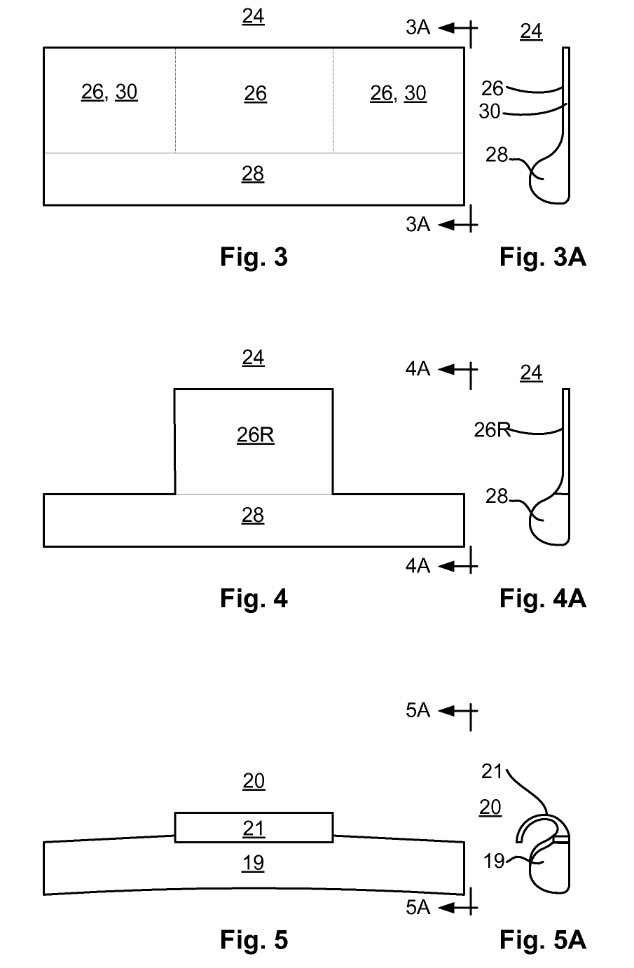

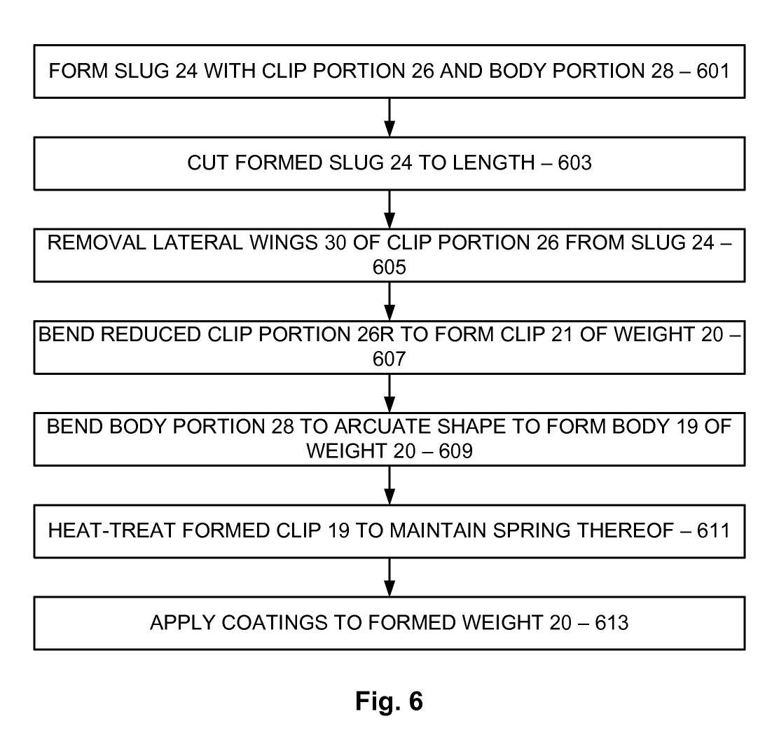

In various embodiments of the present invention, and with reference to the actions set forth in FIG. 6, a weight 20 such as that shown in FIG. 2 is formed with a unitary body and clip 19, 21 from a shaped steel slug 24, as is seen in FIGS. 3 and 3A, where the slug 24 is cut to length from a steel strip (not shown) produced based on an appropriate forming process which may be any appropriate forming process without departing from the spirit and scope of the present invention.

For example, the forming process may be a linear forming process such as an extrusion process, a rolling process, a drawing process, a combination of such processes, or the like. As may be appreciated, such a linear forming process has the benefit that the steel strip produced thereby can be of relatively long length and a correspondingly relatively large number of slugs may be cut therefrom, which as should be appreciated is advantageous in an operation where weights are to be produced in relatively high volume and/or at relatively high rates.

If an extrusion process, such extrusion process receives as an input a steel material, such as for example a steel wire, and outputs the steel strip (601 of FIG. 6) from which the slug 24 is cut to length (603 of FIG. 6). Likewise, if a rolling or drawing process, such rolling or drawing process receives as input a steel material in rolled, slab, or ingot form or the like which is pressed between a series of rollers or drawn through a die to form the steel strip (601) from which the slug 24 is cut (603). As may be appreciated, such extrusion, rolling, and drawing processes may be any appropriate respective processes without departing from the spirit and scope of the present invention, presuming of course that the forming process produces a steel strip having a desired configuration. Such forming processes are known or should be apparent to the relevant public and therefore need not be set forth herein in any detail other than that which is provided.

Cutting the slug 24 from the steel strip may be performed by any appropriate machinery without departing from the spirit and scope of the present invention. For example, such cutting may be performed by a powered shearing machine or by a laser, among other things. The length of the slug 24 as cut from the steel strip may vary based on the predetermined mass that the weight 20 produced from the slug 24 is to have. Thus, longer lengths correspond to increasing mass. As seen in FIG. 3, the slug 24 as cut from the steel strip has cut side edges that are generally normal to generally linear top and bottom edges thereof, although other configurations of the cut side edges may also be employed without departing from the spirit and scope of the present invention.

As best seen in FIG. 3A, the slug 24 as cut from the steel strip includes a generally linear formed clip portion 26 from which the clip 21 of the weight 20 is formed, and a generally linear formed body portion 28 from which the body 19 of the weight 20 is formed. As shown, the clip portion 26 of the slug 24 is relatively thinner in depth from front to back (i.e., left to right in FIG. 3A), has a width that is transverse to the direction of formation (i.e., top to bottom in FIGS. 3 and 3A), and has a length in the direction of formation (i.e., left to right in FIG. 3). Such depth, width, and length may vary without departing from the spirit and scope of the present invention. For example, the depth of the clip portion 26 may be about 0.04 inches, and the width of the clip portion 26 may be about 0.7 inches.

As also shown, the body portion 28 of the slug 24 is relatively thicker in depth from front to back (i.e., left to right in FIG. 3A) as compared with the clip portion 26, has a width (i.e., top to bottom in FIGS. 3 and 3A) that is about the same size as the depth thereof, which is approximately 0.3 inches, and has a length in the direction of formation (i.e., left to right in FIG. 3). Such depth, width, and length may also vary without departing from the spirit and scope of the present invention. As should be understood, the length of the clip portion 26 and of the body portion 28 in the slug 24 are about equal. As shown in FIG. 3A in particular, the body portion 28 of the slug 24 in cross-section may include various flats and curves, which mainly are designed to nestle the body 19 that results from the body portion 28 into the pocket 18 defined by the flange 15 of a rim 11 to which the weight 20 that results from the slug 24 is to be mounted.

Note that, as seen in FIG. 3A, the clip portion 26 and the body portion 28 of the slug 24 are generally co-planar at the back of such slug 24 (i.e., the right side of FIG. 3A). However, and as was alluded to above, such co-planar feature is not believed to be a necessity in all instances and may be removed without departing from the spirit and scope of the present invention. Note also that the clip portion 26 emerges from the body portion 28 gradually such that an intermediary zone is seen therebetween where the depth of the slug 24 (i.e., left to right in FIG. 3A) decreases from that of the body portion 28 to that of the clip portion 26. Such intermediary zone is about 0.15-0.20 inches in width (i.e., top to bottom in FIGS. 3 and 3A) or so as shown. Such intermediary zone may of course vary without departing from the spirit and scope of the present invention but should be sufficiently sized to ensure that the clip 21 that results from the clip portion 26 does not inadvertently separate from the body 19 that results from the body portion 28.

As should be understood, the clip 21 of a weight 20 is likely shorter in length than the body 19 of the weight 20, except when the mass of the weight 20 is relatively small such that the length of the body 19 is relatively short. Put another way, though the body 19 may require an extended length in order to impart a particular mass to a weight 20, the clip 21 of such weight 20 need not likewise have such an extended length to secure the weight 20 to a flange 15 of a rim 11. Moreover, inasmuch as the clip 21 is generally linear but is attached to an arcuate flange 15, it is likely more difficult for the clip 21 to grip the flange 15 as the length of such clip 21 increases.

Thus, and as should also be understood, the length of the clip 21 that results from the clip portion 26 of the slug 24 is likely to be reduced as compared to the length of such clip portion 26. Accordingly, and in various embodiments of the present invention, lateral wings 30 are defined in the clip portion as is seen in FIG. 3, and such lateral wings are removed from the slug 24 as is seen in FIGS. 4 and 4A to leave only a reduced clip portion 26r (605 in FIG. 6). As best shown in FIGS. 3 and 4, such lateral wings 30 are approximately equal in length so that the reduced clip portion 26r is generally centered with respect to the body portion 28 of the slug 24. In addition, such lateral wings 30 have a width substantially equal to that of the clip portion 26 so that substantially all of the clip portion 26 is removed in the area of the lateral wings 30. Accordingly, at least a portion of the aforementioned intermediary zone is likely also removed in the area of the lateral wings 30 when such lateral wings 30 are removed from the slug 24.

As shown, the removed lateral wings 30 are generally rectilinear and thus are formed by cuts in the slug 24 that are generally parallel to the sides thereof. Such cutting of the lateral wings 30 from the slug 24 may be performed by any appropriate machinery without departing from the spirit and scope of the present invention. For example, such cutting may be performed by a powered snipping machine, by a laser, or by a stamping operation, among other things, and may occur immediately after the slug 24 has been cut from the aforementioned steel strip as was set forth above at 603.

After the lateral wings 30 have been removed from the slug 24 as in FIGS. 4 and 4A, such slug 24 is to be formed and/or otherwise shaped as follows to arrive at the weight 20. In particular, and as seen in FIGS. 5 and 5A, the reduced clip portion 26r of the slug 24 is appropriately bent over to form the clip 21 of the weight 20 (607 in FIG. 6), and the body portion 28 of the slug is also appropriately bent to an appropriate arcuate shape to form the body 19 of the weight 20 (609 in FIG. 6).

As seen in FIGS. 5 and 5A, the reduced clip portion 26r is bent over to form the clip 21 such that the top-most edge of such reduced clip portion 26r is urged to the left and then downwardly in FIGS. 4A and 5A. Bending the reduced clip portion 26r in such a manner to form the clip 21 may be performed in most any appropriate manner without departing from the spirit and scope of the present invention. For example, the bending of the reduced clip portion 26r may take place against a die (not shown) formed to define the final shape of the clip 21 after such a bending operation. Likewise, such final shape of the clip 21 after such bending operation may be any appropriate final shape without departing from the spirit and scope of the present invention. Note though, that the final shape of the clip 21 is determined at least in part by the shape of the flange 15 of the rim 11 to which the weight 20 is to be attached, as well as the requirement that such clip 21 is to securely grip such flange 15.

As also seen in FIGS. 5 and 5A, the body portion 28 of the slug is bent to an appropriate arcuate shape to form the body 19 such that the lateral sides of the weight 20 are urged downwardly in FIGS. 4 and 5. Bending the body portion 28 in such a manner to form the body 19 may also be performed in most any appropriate manner without departing from the spirit and scope of the present invention. For example, the bending of the body portion 28 may also take place against a die (not shown) formed to define the final arcuate shape of the body 19 after such a bending operation. Likewise, such final arcuate shape of the body 19 after such bending operation may be any appropriate final arcuate shape without departing from the spirit and scope of the present invention. Note though, that the final arcuate shape of the body 19 is determined at least in part by the shape of the pocket 18 defined by the flange 15 of the rim 11 to which the weight 20 is to be attached, as well as the requirement that such body 19 be nestled within such pocket 18 when the clip 21 secures the weight 20 to such flange 15.

The bending of the reduced clip portion 26r to form the clip 21 and of the body portion 28 to form the body 19 as at 607 and 609 may be performed by any appropriate machinery without departing from the spirit and scope of the present invention. For example, such bending 607 and 609 may be performed by one or more powered pressing machines, and may be done serially or essentially simultaneously. If done serially, separate machines or a single machine may be employed, and either the body 19 or the clip 21 may be bent first. If done simultaneously, a single machine would be employed. In either case where a single machine is employed, such single machine would of course include both the mechanism for bending the reduced clip portion 26r to form the clip 21 as at 607 and the mechanism for bending the body portion 28 to form the body 19 as at 609. Additionally, such bending of the body 19 and the clip 21 may occur immediately after the lateral wings 30 have been removed from the slug 24 as was set forth above as at 605.

Note here that the weight 20 can be formed from the slug 24 essentially within a single machine if such single machine is constructed to perform all of the actions as set forth above. Alternately, at least some of the actions can be performed by such a single machine. Notably, such a single machine could perform at least some of the actions on the slug 24 at a single station within such machine, and without moving same from one station to another. Thus, registering and positioning the slug 24 at such a single station need only be performed once, and errors from multiple registrations and positionings may be avoided. For example, it may be that cutting the lateral wings 30 as at 605 and bending the body 19 and clip 21 as at 607 and 609 may be performed at such single station.

Note too that in an alternate embodiment of the present invention, the slug 24 as formed is not generally linear but instead is formed such that the body portion 28 thereof is already generally arcuate. Forming such an arcuate formed slug is known or should be apparent to the relevant public and therefore need not be set forth herein in any detail. If already arcuate as formed, the body portion 28 of the slug 24 need not be bent as at step 609.

Once the final shape of the weight 20 with the body 19 and the clip 21 has been arrived at, as is shown in FIGS. 5 and 5A, the weight 20 is essentially complete, although additional actions may be taken as necessary and/or desired. For example, the formed clip 21 may be heat-treated to maintain the spring thereof (611 of FIG. 6), and/or one or more coatings may be applied to the weight 20 (613 of FIG. 6). Such coatings may be any appropriate coatings without departing from the spirit and scope of the present invention. For example, such coatings may include a mechanical plating of a material for aesthetic purposes and/or for corrosion protection purposes, and may include a polymer coating for corrosion protection purposes. Such coatings may also include a friction-enhancing material to increase the frictional contact of the clip 21 with the flange 15 of the rim 11 to which the weight 20 is attached, although such a friction coating is not believed to be necessary in all instances and could in fact be detrimental if such frictional coating mars the flange 15 during insertion and removal of the weight 20.

As thus far set forth herein, the weight 20 having the unitary body 19 and clip 21 is formed from a steel material. However, such a unitary weight 20 may also be formed from any other appropriate material without departing from the spirit and scope of the present invention. Note, though, that steel is presently preferred, especially inasmuch as steel is relatively pliable and may be formed and bent with relative ease to form the weight 20, and also inasmuch as a steel clip 21 can be formed with relative ease to maintain the spring thereof without substantial loss or fatigue.

It is to be noted that by forming a weight 20 having a unitary body 19 and clip 21 in the manner set forth above, it has been estimated that a single production line can produce about 100 formed weights 20 per minute, if not more. Such a rate of production is believed to be a considerable improvement over previous processes, and particularly processes that involved casting the body 19 separately from the clip 21, where the production rate for a single production line is about 20-50 per minute.

### CONCLUSION

In the foregoing description, it can be seen that the present invention comprises a new and useful wheel-balancing weight 20 with a unitary body 19 and clip 21 formed from a material such as a formed steel. The clip 21 is attached to the body 19 in a simplified manner by being formed with such body 19 and emerging therefrom, and with reduced or eliminated join issues. The clip 21 and body 19 are formed as a unitary member with a reduced number of production steps, and based on a forming and tooling process that is affordable in cost and high in production rate.

It should be appreciated that changes could be made to the embodiments described above without departing from the inventive concepts thereof. For one example, the clip 21 may emerge from the body 19 at an alternate location. For another example, the presence of a tire 10 is not essential to the present invention and the invention encompasses the use of the wheel-balancing weight 20 to counter-balance the wheel 12 only. It should be understood, therefore, that this invention is not limited to the particular embodiments disclosed, but it is intended to cover modifications within the spirit and scope of the present invention as defined by the appended claims.

1. A wheel-balancing weight for mounting to a wheel with a flange, the weight formed as a unitary member having a unitary body and clip such that the clip as formed is attached to and emerges from the body as formed, the body for providing a predetermined mass to the weight and the clip for securely grasping the flange to secure the weight thereto,
the weight being formed from a formed steel slug shaped during formation thereof to include a formed body portion corresponding to the body and a formed clip portion corresponding to the clip, the formed body portion and the formed clip portion of the formed slug being generally equal in formed length, the formed clip portion including opposing lateral formed wings that are removed from the formed clip portion to leave a remaining formed clip portion as the clip, the opposing lateral formed wings being removed by cutting the slug between each lateral wing and the remaining formed clip portion and between each lateral wing and the formed body portion, the remaining formed clip portion and the formed body portion including cut marks where the lateral wings were cut therefrom.

2. The weight of claim 1 formed from a steel material by a linear forming process including at least one of an extrusion process, a rolling process, and a drawing process.

3. The weight of claim 1 formed from a formed steel slug cut to length from a formed steel strip.

4. (canceled)

5. The weight of claim 1 wherein the formed clip portion has a first thickness and the formed body portion has a second thickness, the first thickness of the formed clip portion being less than the second thickness of the formed body portion such that the formed clip portion can be bent over to form the clip.

6. The weight of claim 1 wherein the remaining formed clip portion is bent over to form the clip.

7. The weight of claim 1 wherein the remaining formed clip portion is generally centered with respect to the formed length of the formed body portion.

8. The weight of claim 1 wherein the formed body portion is bent into an arcuate form at about where the lateral formed wings were removed such that the arcuate form of the formed and bent body portion matches an arcuate form of the flange.

9. A method of forming a wheel-balancing weight for mounting to a wheel with a flange, the weight being formed as a unitary member having a unitary body and clip such that the clip as formed is attached to and emerges from the body as formed, the body for providing a predetermined mass to the weight and the clip for securely grasping the flange of the wheel to secure the weight thereto, the method comprising:
forming a slug to include a formed body portion corresponding to the body and a formed clip portion corresponding to the clip; and
bending over at least a portion of the formed clip portion of the slug to form the clip.

10. The method of claim 9 wherein the formed slug is a steel slug.

11. The method of claim 9 further comprising cutting the formed slug to length from a formed strip, the length of the slug corresponding to the predetermined mass of the weight.

12. The method of claim 9 wherein the formed clip portion and the formed body portion of the slug each have a generally equal length.

13. The method of claim 9 further comprising defining opposing formed lateral wings in the formed clip portion and removing the formed lateral wings to leave a reduced formed clip portion, and comprising bending over the reduced formed clip portion of the slug to form the clip.

14. The method of claim 13 further comprising bending the formed body portion into an arcuate form at about where the lateral formed wings were removed such that the arcuate form of the formed and bent body portion matches an arcuate form of the flange.

15. The method of claim 9 comprising forming the slug such that the formed body portion and the formed clip portion are generally co-planar at a side of the slug.

16. The method of claim 9 further comprising bending the formed body portion into an arcuate form that matches an arcuate form of the flange to form the body.

17. The method of claim 9 comprising forming the slug to include a formed arcuate body portion corresponding to the body and a formed clip portion corresponding to the clip, the arcuate body portion matching an arcuate form of the flange.

18. The method of claim 9 further comprising heat-treating at least the formed clip to maintain a spring thereof.

19. A method of forming a wheel-balancing weight for mounting to a wheel with a flange, the weight being formed as a unitary member having a unitary body and clip such that the clip as formed is attached to and emerges from the body as formed, the body for providing a predetermined mass to the weight and the clip for securely grasping the flange of the wheel to secure the weight thereto, the method comprising:
forming a slug to include a formed body portion corresponding to the body and a formed clip portion corresponding to the clip;
defining opposing formed lateral wings in the formed clip portion and removing the formed lateral wings to leave a reduced formed clip portion;
bending over the reduced formed clip portion of the slug to form the clip; and
bending the formed body portion into an arcuate form at about where the lateral formed wings were removed such that the arcuate form of the formed and bent body portion matches an arcuate form of the flange.

20. The method of claim 19 wherein the removed lateral wings are generally equal in length such that the reduced formed clip portion is generally centered with respect to the formed body portion.

21. The method of claim 19 wherein the removed lateral wings have a width generally equal to a width of the formed clip portion so that substantially all of the formed clip portion is removed in an area of the removed lateral wings.

22. The method of claim 19 comprising forming the slug such that the formed clip portion emerges from the formed body portion gradually with an intermediary zone therebetween where a depth of the slug decreases from the body portion to the clip portion.
